(19) United States
(12) Patent Application Publication
(10) Pub. No.: US 2015/0175837 A1
(43) Pub. Date: Jun. 25, 2015

(54) COATING MATERIALS AND LOW HAZE HEAT REJECTION COMPOSITES

(71) Applicant: Saint-Gobain Performance Plastics Corporation, Aurora, OH (US)

(72) Inventors: Blair K. Brettmann, Cambridge, MA (US); Aziz Mahfoud Familia, Shrewsbury, MA (US); Choung H. Lai, Acton, MA (US); Robrecht Moerkerke, Kortrijk (BE); Mithun Kamath, Shrewsbury, MA (US)

(21) Appl. No.: 14/572,432

(22) Filed: Dec. 16, 2014

Related U.S. Application Data
(60) Provisional application No. 61/919,927, filed on Dec. 23, 2013.

(51) Int. Cl. C09D 133/14; C08K 3/22

(52) U.S. Cl. CPC C09D 133/14; C08K 3/22; C08K 2003/2258; C08K 2003/2237

(57) ABSTRACT

A coating material includes a binder system and particles dispersed in the binder system. A composite includes a substrate and a coating layer comprising a binder system and particles dispersed in the binder system. A method for manufacturing a coating material, or a composite having a coating layer, includes providing a binder system and dispersing particles in the binder system.

### FIELD OF THE DISCLOSURE

The present disclosure relates coatings based on infrared-attenuating particles and more particularly to solar heat rejection composites comprising such coatings.

### RELATED ART

Composites that attenuate solar radiation in the near infrared spectrum (800-2500 nm) while transmitting radiation in the visible spectrum have important applications, for example as windows in building or vehicles. However, such composites may need the visible light transmittance to be high, and hence the reflectivity and absorptivity of visible light must be low. For example, in some countries, automotive windshields must have a transmittance of visible light of at least 70%.

In response to this need, certain composites have been developed based on metal layers, such as silver or aluminum, coated on glass and clear polymer materials that reflect both the short and long infrared wavelengths. However, manufacturing such composites can be expensive due to the high cost of depositing the metal layers through methods such as magnetron-sputtering.

As a lower-cost solution, composites have been developed based on coatings that include particles, such as nanoparticles, that attenuate infrared radiation. However, the particles can interact with the substrate and the binder to cause light scattering, resulting in a haze greater than the haze of the substrate itself. The haze contribution of the particle coatings can be more pronounced at shorter wavelengths of light.

As such, a need exists for particle coatings that contribute less haze to the overall haze of the composite. A need also exists for composites comprising particle coatings that also have superior visible light transmissive properties.

### BRIEF DESCRIPTION OF THE DRAWINGS

Embodiments are illustrated by way of example and are not limited in the accompanying figures.

FIG. 1 includes an illustration of a coating material according to one embodiment of the present disclosure.

FIG. 2 includes an illustration of a composite according to one embodiment of the present disclosure.

FIG. 3 includes a graph showing the haze profile of the composites described in Example 1 of the present disclosure.

FIG. 4 includes a graph showing the haze profile of the composites described in Example 2 of the present disclosure.

FIG. 5 includes a graph showing the haze profile of the composites described in Example 3 of the present disclosure.

FIG. 6 includes a graph showing the haze profile of the composites described in Example 4 of the present disclosure.

FIG. 7 includes a graph showing the haze profile of the composites described in Example 5 of the present disclosure.

FIGS. 8-10 include graphs showing the haze profiles of the composites described in Example 6 of the present disclosure.

FIG. 11 includes a graph showing the haze profile of the composites described in Example 7 of the present disclosure.

FIG. 12 includes a graph showing the haze profile of the composites described in Example 8 of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the solar control film arts.

The present disclosure describes infrared-attenuating coating materials and composites comprising infrared-attenuating coating materials. Also described are methods for forming infrared-attenuating coating materials and composites comprising infrared-attenuating coating materials. As explained in more detail below, certain embodiments of the coating material described herein can reduce the haze resulting from the interaction between the particles and the binder and/or substrate.

In solar control films, the clarity of the visible transmitted light can be a measure of the quality of the film itself. The amount the clarity of the transmitted visible light is reduced is often referred to as haze and can be represented as a percentage. The haze of the solar control film can include the haze caused by the substrate and the haze caused by the coating material. The haze caused by the coating material can be a result of interactions between the particles and the substrate and/or binder system that scatter the light.

When the particles in the coating material are smaller than 1/10 the wavelength of light, the scattering can be described by Rayleigh scattering. However, scattering for larger particles is better described by Mie scattering. If most particles in the coating material are smaller than a particular wavelength of light (especially in the red spectrum), the scattering phenomenon can be compatible with Rayleigh scattering. As the wavelength of light approaches the blue spectrum, Rayleigh scattering might not be enough to explain the scattering process and the Mie scattering regime might be more appropriate. In short, addressing the light-scattering phenomenon in solar control films can be complicated.

Surprisingly, reducing the mismatch between the refractive index of the binder system and the refractive index of the particles can reduce light scattering and, thus, reduces the haze caused by the coating material. Although reducing the mismatch of the refractive index of the binder system and the particles can have disadvantages such as poor hardness or poor adhesion, certain high-refractive-index coatings cause less haze, particularly in short wavelengths of the visible light spectrum, while minimizing or avoiding such disadvantages. Of course, a reduction in the haze caused by the coating material can result in a reduction in the overall haze of the solar film. The concepts are better understood in view of embodiments described below that illustrate and do not limit the scope of the present invention.

The coating material can be described in terms of the amount of haze it causes when applied to a given substrate. For purposes of this disclosure, the amount of haze caused by the coating material will be referred to as its haze contribution. The haze contribution of the coating material (HC_{coating}) at a given wavelength can be determined based on the following measurements at that wavelength: the total haze of the composite (H_{composite}) and the haze of the substrate alone (H_{substrate}). For example, the haze contribution of an embodiment of the coating material at 390 nm can be determined according to the following formula:

H_{composite at 390 nn}=HC_{Coating at 390 nm}+H_{substrate at 390 nm}.

In certain embodiments, coating material can have a haze contribution of no greater than 20%, no greater than 15%, no greater than 12%, or no greater than 10%, no greater than 9%, or no greater than 8%, no greater than 7%, no greater than 6%, no greater than 5%, no greater than 4%, or even no greater than 3%. In further embodiments, the coating material can have a haze contribution of no less than 0.1%, no less than 0.2%, no less than 0.3%, no less than 0.4%, or no less than 0.5%. Moreover, the coating material can have a haze contribution in a range of any of the maximum and minimum values described above, such as, from about 0.1% to about 20%, from 0.5% to 10%, from 1% to 8%, or from 2% to 5%. The values for the haze contribution of the coating layer are values measured according to a spectrophotomer at 390 nm.

The haze contribution of the coating material can depend on substrate on which it is disposed. In other words, the haze contribution of certain embodiments of the coating material when applied to one substrate can be higher or lower than the haze contribution of the same coating material when applied to another substrate.

In certain embodiments, the coating material has a haze contribution that can change based on the visible light transmittance (VLT) of the composite. VLT is a measure of the amount of light in the visible spectrum (380 to 780 nanometers) that is transmitted through a composite, typically presented as a percentage. The VLT can be measured according to standard ISO 9050. Although ISO 9050 refers to glazings, the same procedure can be used with a film taped or otherwise adhered to a transparent substrate.

In particular embodiments, the coating material can have a haze contribution that decreases as the VLT of the substrate composite increases. For example, a coating material disposed on a substrate having a VLT of 40% can have a haze contribution of about 10%, whereas the same coating layer disposed on a substrate having a VLT of 66% can have a haze contribution of about 5%. The haze contribution of the coating material relative to the VLT of the substrate (HCᵥₗₜ) can be determined by the following equation:

HCᵥₗₜ=(HC_{coating})/(1−VLT).

As discussed above, the performance of a coating material can be improved by providing particles and binder systems having desired refractive index values. The refractive index values listed herein are calculated through ellipsometry, unless otherwise stated.

In certain embodiments, the particles in the coating material can having a refractive index of no less than 2.0, no less than 2.05, no less than 2.1, no less than 2.15, no less than 2.2, no less than 2.25, or even no less than 2.3. In further embodiments, the coating layer can comprise particles having a refractive index of no greater than 2.8, no greater than 2.75, no greater than 2.7, no greater than 2.65, or no greater than 2.6. Moreover, the particles can have a refractive index in a range of any of the maximum and minimum values described above, such a refractive index in a range of from 2.0 to 2.8, or from 2.1 to 2.75, or from 2.2 to 2.7, or from 2.3 to 2.65, or from 2.4 to 2.6.

In certain embodiments, the binder system can have a refractive index of no less than 1.50, no less than 1.51, no less than 1.52, or no less than 1.53. In further embodiments, the binder system can have a refractive index of no greater than 1.60, no greater than 1.59, no greater than 1.58, or even no greater than 1.57. Moreover, the binder system can have a refractive index in a range of any of the maximum and minimum values described above, such as from 1.50 to 1.60, from 1.50 to 1.59, from 1.51 to 1.58, from 1.52 to 1.57, or from 1.53 to 1.56.

In particular, in certain embodiments, reducing the mismatch between the refractive index of the binder system and the refractive index of the particles can reduce the haze contribution of a coating material. The measure of how closely the refractive index of the binder system matches the refractive index of the particles can be referred to as the refractive index difference. For example, where the particles of the coating material have a refractive index A and the binder system of the coating material has a refractive index B, the refractive index difference is determined by the difference between A and B.

In certain embodiments, the coating material can have a refractive index difference of no greater than 1.5, no greater than 1.4, no greater than 1.3, no greater than 1.2, or even no greater than 1.1. In further embodiments, the refractive index difference can be no less than 0.1, no less than 0.2, no less than 0.3, no less than 0.4, or no less than 0.5. Moreover, the refractive index difference of the coating material can be in a range of any of the maximum and minimum values described above, such as from 0.1 to 1.5, from 0.3 to 1.3, or from 0.5 to 1.1.

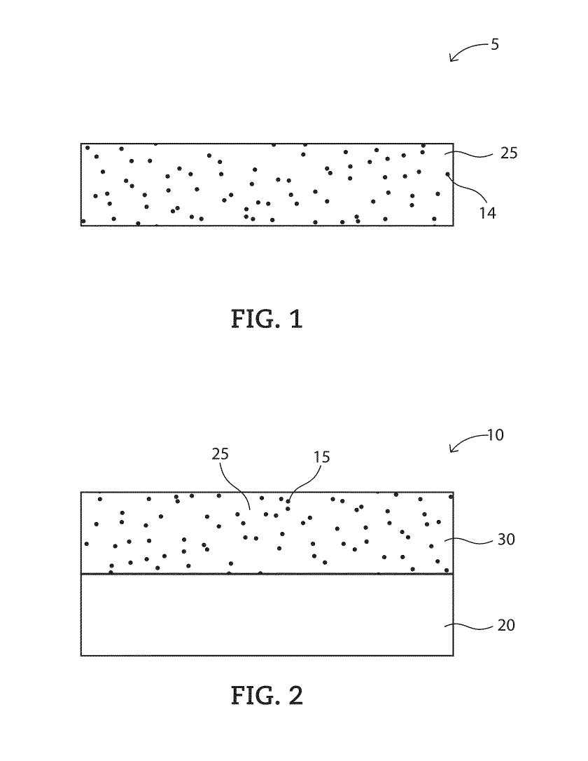

The coating material can be described in terms of its composition. FIG. 1 illustrates a cross-section of an infrared-attenuating coating material 5 according to one embodiment of this disclosure. The coating material 5 can include binder system 15 and particles 25. It is to be understood that the coating material 5 illustrated in FIG. 1 is an illustrative embodiment. Embodiments with any number of additional components, or fewer components, than shown are within the scope of the present disclosure.

In certain embodiments, the coating layer can comprise the particles in an amount of no less than 1 wt. %, no less than 2 wt. %, no less than 3 wt. %, no less than 4 wt. %, no less than 5 wt. %, no less than 6 wt. %, no less than 7 wt. %, no less than 8 wt. %, or even no less than 9 wt. %. In further embodiments, the coating layer can comprise the particles in an amount of no greater than 50 wt. %, no greater than 40 wt. %, no greater than 30 wt. %, no greater than 20 wt. %, or no greater than 15 wt. %. Moreover, the coating layer can comprise particles in a range of any of the maximum and minimum values described above, such as from 1 wt. % to about 30 wt. %, from about 5 wt. % to about 20 wt. %, or even from about 9 wt. % to about 15 wt. %. The above content values are values calculated based on the total weight of the coating composition.

In certain embodiments, the coating material can comprise particles of a desired size. For example, the particles can be fine particles or nanoparticles. As used herein, the term “fine particles” refers to nanoparticles having a diameter of no greater than 500 nm. In particular embodiments, the particles can have a diameter of no greater than 300 nm, no greater than 200 nm, no greater than 150 nm, or no greater than 100 nm. In further embodiments, the particles can have a diameter of no less than 1 nm, no less than 20 nm, no less than 30 nm, or no less than 40 nm. Moreover, the particles can have a diameter in a range of any of the maximum and minimum values described above, such as from 20 nm to 200 nm, from 30 nm to 150 nm, or even from 40 nm to 100 nm.

In certain embodiments, the coating material can comprise particles that exhibit a desired infrared attenuance and transmission in the visible range. For example, the coating material can comprise a fine particle dispersion having a desired infrared attenuance and desired transmission in the visible range.

In particular embodiments, the coating material can have a VLT of no less than 10%, no less than 30%, no less than 40%, no less than 65%, no less than 70%, no less than 75%, no less than 80%, or no less than 85%. In further particular embodiments, the coating material can have a VLT of no greater than 99%, no greater than 95%, or no greater than 90%. Moreover, the coating material can have a VLT in a range of any of the maximum and minimum values described above, such as from 10% to 99%, from 70% to 95%, or from 75% to 90%.

In further embodiments, the coating material can absorb infrared radiation, such as infrared radiation in the range of 1000 nm or longer wavelengths. In particular embodiments, the coating material can have a transmittance of infrared light of no greater than 50%, no greater than 40%, no greater than 30%, no greater than 20%, no greater than 15%, no greater than 10%, or no greater than 5%. In further particular embodiments, the coating material can have a transmittance of infrared light of no less than 0.1%, no less than 0.5%, no less than 1%, no less than 2%, or no less than 3%. Moreover, the coating material can have a transmittance of infrared light in a range of any of the maximum and minimum values described above, such as from 0.1 to 20%, or from 0.5% to 15%, or from 1% to 10%.

In certain embodiments, the coating material can comprise particles of a desired composition. In particular embodiments, the particles can comprise an inorganic compound, an oxide, or a metal oxide. In even more particular embodiments, the particles can comprise tungsten oxide, antimony tin oxide, indium tin oxide, and lanthanum hexaboride. In very particular embodiments, the particles can comprise tungsten oxide.

In further embodiments, the particles can comprise composite metal nitrides. As used herein, the term “composite metal nitride” refers to a metal nitride that contains metal and nitrogen. The metal can comprise Ti, Ta, Zr, Hf, or any combination thereof.

In further embodiments, the particles can comprise composite metal hexaboride. As used herein, the term “composite metal boride” refers to a metal boride that contains metal and boron. The metal can comprise La, Ho, Dy, Tb, Gd, Nd, Pr, Ce, Y, Sm, or any combination thereof.

In further embodiments, the particles can comprise composite metal oxides. As used herein, the term “composite metal oxide” refers to a metal oxide that contains metal, oxygen, and at least one additional element. In particular embodiments, the at least one additional element in the composite metal oxide can comprise H, He, an alkali metal, an alkaline earth metal, a rare earth element, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, I, or any combination thereof. In even more particular embodiments, the at least one element in the composite metal oxide can be Cs, Na, Rb, Ti, or any combination thereof.

Moreover, in certain embodiments, the particles can comprise tungsten oxide composite particles. In particular embodiments, the tungsten oxide composite particles can have a general formula of MₓW_{y}O_{z}, where M comprises Cs, Na, Rb, Ti, or any combination thereof. In an even more particular embodiment, M can be Cs. For example, the particles can have a general formula of CsₓW_{y}O_{z}, where x has a value in a range of from 0.1 to 0.5, from 0.12 to 0.45, from 0.13 to 0.4, from 0.14 to 0.35, or even from 0.15 to 0.33. In very particular embodiments, x has a value in a range of from 0.15 to 0.33.

In certain embodiments, the coating material can comprise a binder system in an amount of no greater than 99 wt. %, no greater than 98 wt. %, no greater than 97 wt. %, no greater than 93 wt. %, no greater than 94 wt. %, no greater than 93 wt. %, no greater than 92 wt. %, or no greater than 91 wt. %. In further embodiments, the coating layer can comprise the binder system in an amount of no less than 15 wt. %, no less than 20 wt. %, no less than 25 wt. %, no less than 30 wt. %, no less than 35 wt. %, or even no less than 40 wt. %. Moreover, the coating material can comprise the binder system in a range of any of the maximum and minimum values described above, such as from about 99 wt. % to 70 wt. %, or from 95 wt. % to 80 wt. %, or from 91 wt. % to 85 wt. %. The above content values are values calculated based on the total weight of the coating composition.

In certain embodiments, the coating material can comprise a binder system of a desired composition. In particular embodiments, the binder system can contain, for example, a monomer or an oligomer, such as an ultraviolet (UV)-curable monomer or oligomer. In particular embodiments, the monomer or oligomer contained in the binder system can be, for example, an aromatic monomer or oligomer. In further particular embodiments, the monomer or oligomer can contain an acrylate monomer or oligomer, such as an epoxy acrylate monomer or oligomer, such as an aromatic epoxy acrylate monomer or oligomer, such as a partially-acrylated bisphenol A epoxy monomer or oligomer, a difunctional bisphenol A based epoxy acrylate blended with glyceryl propoxy triacrylate, or a brominated aromatic acrylate oligomer. In even further particular embodiments, the binder system can contain an acrylic resin, a mixture of an acrylate monomer and an acrylic resin, an acrylic ester oligomer. In certain embodiments, the binder system can be any combination of the above oligomers and monomers.

Besides the refractive index, there are a number of key properties that can be considered when selecting a binder system. These properties can include a high adhesion to the substrate, a high scratch resistance and hardness of the coating, a neutrality of the color of the binder, a high chemical resistance, a high heat resistance, a high flexibility, a high water resistance, high UV cure response rate, a high resistance to UV degradation and other chemical hazards associated with a binder. In addition to these end product properties, a number of characteristics can affect the processability of the binder system, including the viscosity, surface tension, density, and compatibility with other materials in the system. One or more of the above properties or characteristics can affect the performance of the coating material for a given application.

As discussed above, the coating material can be applied to a substrate to form a composite. FIG. 2 illustrates a cross section of an infrared-attenuating composite 10 according to one embodiment of the present disclosure. Composite 10 can include substrate layer 20 and coating layer 30. For example, referring to FIG. 2, the coating layer 30 can be disposed over the substrate layer. Generally, the coating layer can be disposed adjacent to, or even, directly contacting a major surface of a substrate layer. It is to be understood that composite film 10 illustrated in FIG. 2 is an illustrative embodiment. Any number of additional layers, or fewer layers than shown, can be within the scope of the present disclosure.

In certain embodiments, the composite can be a composite film, such as a solar film, or a low haze solar film. In particular embodiments, the composite can be a low haze solar film adapted to be disposed on a substrate. When used as a solar film for application to a rigid surface, such as a window, the substrate layer can be adapted to be disposed adjacent a surface to be covered with the film. For example, when attached to, for example, a window, the substrate layer can be nearer the window than the coating layer. Moreover, an adhesive layer can be disposed adjacent the substrate layer and adapted to adhere the window or other surface to be covered with the composite. The composite is described in more detail below.

Particular advantages of the composite can be described in terms of its performance. Parameters include haze, visible light transmittance, total solar energy rejection, solar heat gain coefficient, light to solar gain ratio.

The haze values described herein are measured using ATSM D1003 on the film sample. The Visible Light Transmittance (VLT) values measured on a spectrophotometer and is characterized by the VLT at 550 nm. The total solar energy rejection (TSER), solar heat gain coefficient (SHGC), total solar energy transmittance, total solar energy reflectance, and light to solar heat gain coefficient (LSHGC) are calculated using Window6 and Optics6 software packages freely available from Lawrence Berkeley National Lab. The transmission from 300 nm to 2500 nm, the reflection on one side of the film from 300 nm to 2500 nm and the reflection on the other side of the film from 300 nm to 2500 nm are measured using a Perkin Elmer Lambda 950 spectrophotomer. The data is then input into the Optics6 software and an Optics file is created. The Optics file is then input into the Window6 software and the parameters are calculated using the environmental conditions NFRC 100-2001, a single layer, and a tilt of 90 degrees.

As described above, the composite can exhibit improved reduction in haze. In certain embodiments, the composite can have a haze of no greater than 30%, no greater than 25%, no greater than 20%, no greater than 15%, no greater than 10%, no greater than 9%, no greater than 8%, no greater than 7%, no greater than 6%, no greater than 5%, no greater than 4%, or even no greater than 3%. In further embodiments, the composite can have a haze of no less than 0.1%, no less than 0.5%, or no less than 1%. Moreover, the composite can have a haze in a range of any of the above maximum and minimum values, such as from 0.1% to 10%, from 0.5% to 8%, or even from 1% to 3%. A particular advantage of the present disclosure is the ability to obtain the haze (and haze contribution) values described herein and illustrated in the Examples below, especially in combination with the other parameters described below.

The composite can exhibit a desired VLT. In certain embodiments, the composite can have a VLT of no less than 10%, no less than 35%, no less than 40%, no less than 45%, no less than 50%, no less than 55%, no less than 60%, no less than 65%, no less than 68%, no less than 70%, no less than 73%, or even no less than 75%. In further embodiments, the composite can have a VLT of 100%, such as no greater than 95%, no greater than 90%, no greater than 88%, no greater than 86%, no greater than 84%, no greater than 82%, no even no greater than 80%. For example, the composite can have a VLT in a range of any of the above maximum and minimum values, such as from 30% to 50%, from 50% to 70%, or from 60% to 80%.

The composite can exhibit a desired Total Solar Energy Rejection (TSER). TSER is a measurement of the total energy rejected by a film which is the sum of the solar direct reflectance and the secondary heat transfer rejection factor towards the outside, the latter resulting from heat transfer by convection and longwave IR-radiation of that part of the incident solar radiation which has been attenuated by the film. The total solar energy rejection can be measured according to standard ISO 9050. A particular advantage of the present disclosure is the ability to obtain the total solar energy rejection values described herein and illustrated in the Examples below, especially in combination with the other parameters described herein.

In particular embodiments of the present disclosure, the composite can have a TSER of no less than 35%, no less than 52%, no less than 55%, or even no less than 59%. Further, the composite can have a total solar energy rejection of no greater than 90%, no greater than 80%, or even no greater than 70%. Moreover, the composite can have a total solar energy rejection in a range of any of the maximum and minimum values described above, such as from about 50% to about 90%, or even from about 59% to about 80%.

The composite can exhibit a desired Light to Solar Heat Gain Coefficient (LSHGC). LSHGC refers to a gauge of the relative efficiency of different composite types in transmitting daylight while blocking heat gains The higher the ratio, the brighter the room is without adding excessive amounts of heat. The light to solar heat gain coefficient can be determined by the following equation:

LSHGC=(VLT)/(TSER*100)

where VLT and TSER are determined as described above.

In particular embodiments of the present disclosure, the composite can have a LSHGC of at least 1, such as at least 1.1, such as at least, 1.2, such as at least, 1.3, such as at least 1.4, such as at least 1.5, such as at least 1.6, as measured according to a spectrophotomer and calculated by Windows software. Further, the composite can have a LSHGC of no greater than 1.95, no greater than 1.92, or even no greater than 1.90. Moreover, the composite can have an LSHGC in a range of any of the maximum and minimum values described above, such as from about 1.60 to about 1.95, or even 1.80 to about 1.90.

The total solar energy absorptance (TSEA) is a measurement of the amount of solar energy absorbed by a composite. The TSEA can be determined by the following equation:

TSEA=100−(total solar energy transmittance)−(total solar energy reflectance), where solar energy transmittance and solar energy reflectance are calculated using Window6 and Optics6 software packages freely available from Lawrence Berkeley National Lab. The transmission from 300 nm to 2500 nm, the reflection on one side of the film from 300 nm to 2500 nm and the reflection on the other side of the film from 300 nm to 2500 nm are measured using a Perkin Elmer Lambda 950 spectrophotometer. The data is then input into the Optics6 software and an Optics file is created. The Optics file is then input into the Window6 software and the parameters are calculated using the environmental conditions NFRC 100-2001, a single layer, and a tilt of 90 degrees.

In particular embodiments of the present disclosure, the composite can have a TSEA of no less than 30%, no less than 40%, no less than 50%, no less than 60%, or even no less than 70%, as measured by a spectrophotometer and calculated with the Window software. In further embodiments, the composite can have a TSEA of 100%, or no greater than 95%, or no greater than 90%, or even no greater than 85%. Moreover, in more particular embodiments, the composite can have a TSEA in a range of any of the maximum and minimum values described above, such as in a range of 30% to 100%, or 40% to 95%, or from 70% to 90%.

The composite can comprise a substrate layer having a desired composition. The substrate can be composed of any number of different materials. In certain embodiments, the substrate layer can comprise a polymer. In particular embodiments, the substrate layer can comprise polycarbonate, polyacrylate, polyester, polyethylene, polypropylene, polyurethane, fluoropolymer, cellulose triacetate polymer, or any combination thereof. In very particular embodiments, the substrate layer can contain polyethylene terephthalate (PET). In further particular embodiments, the substrate layer can contain a glass substrate.

The composite can comprise a substrate layer having a desired rigidity. The substrate can be a rigid or semi-rigid. As used herein, the term “rigid” refers to a condition where a material has a Young's modulus value greater than 500 MPa and the term “semi-rigid” refers to a condition where a material has a Young's Modulus value in a range of from 10 MPa to 500 MPa.

The composite can comprises a substrate layer having a desired VLT. In certain embodiments, the substrate layer can comprise a transparent substrate. As used herein, “transparent” refers to a condition where a material has a VLT of no less than 5%. In particular embodiments, the transparent substrate can have a VLT of no less than 10%, no less than 20%, no less than 30%, no less than 40%, no less than 50%, no less than 60%, or even no less than 70%. In further particular embodiments, the transparent substrate can have a VLT of 100%, or no greater than 95%, no greater than 90%, no greater than 85%, no greater than 80%, or no greater than 75%. Moreover, the transparent substrate can have a VLT in a range of any one of the maximum and minimum values described above, such as in a range of from 40% to 85% or from 50% to 85%.

In certain embodiments, the substrate layer can comprise a high-VLT substrate. As used herein, the term “high-VLT substrate” refers to a substrate having a VLT of no less than 60%. In certain embodiments, a high-VLT substrate can have a VLT of no less than 65%, no less than 68%, or no less than 70%. In further particular embodiments, the high-VLT substrate can have a VLT of no greater than 80%, no greater than 85%, no greater than 90%, no greater than 95%, or even up to 100%. Moreover, the high-VLT substrate can have a VLT in a range of any one of the maximum and minimum values described above, such as in a range of from 60% to 85% or even from 65% to 80%. In very particular embodiments, the substrate can have a VLT in a range of from 65% to 75%.

In particular embodiments, the substrate layer can comprise a low-VLT substrate. As used herein, a low-VLT substrate refers to a substrate having a VLT of less than 60%. In particular embodiments, the low-VLT substrate can have a VLT of no greater than 58%, or no greater than 55%, or no greater than 53%, or even no greater than 50%. In further particular embodiments, the low-VLT substrate can have a VLT of no less than 25%, no less than 30%, no less than 35%, or no less than 40%. Moreover, the low-VLT substrate can have a VLT in a range of any of the maximum and minimum values described above, such as in the range of from 30% to 55% or even from 35% to 50%. Suitable low-VLT substrates include, for example, dyed, metalized, or extruded substrates.

The composite can comprise a substrate layer having a desired thickness. In certain embodiments, the substrate layer can have a thickness of at least about 0.1 micron, at least about 1 micron, or even at least about 10 microns. In further embodiments, the substrate layer can have a thickness of no greater than about 1000 microns, no greater than about 500 microns, no greater than about 100 microns, or even no greater than about 50 microns. Moreover, the substrate layer can have a thickness in a range of any of the maximum and minimum values described above, such as, from about 0.1 microns to about 1000 microns, from about 1 micron to about 100 microns, or even, from about 10 microns to about 50 microns.

In further embodiments, the substrate layer can have a greater thickness, such as from 1 millimeter to 50 millimeters, or even 1 millimeter to 20 millimeters. In even other embodiments, the substrate can have a thickness of at least 0.001 inches, at least 0.01 inches, at least 0.1 inches, at least one inch, or at least 10 inches. For example, such substrate layers can include a rigid substrate, such as glass.

In further embodiments, the substrate layer can include an infrared reflecting substrate. In particular embodiments, the infrared reflecting substrate can include an infrared reflecting film. In more particular embodiments, an infrared reflecting film can be included in the substrate layer to combine infrared reflection with the infrared absorption of embodiments of the coating layer.

In certain embodiments, the coating layer has a thickness of no greater than 50 microns, no greater than 20 microns, or even no greater than 10 microns. In further embodiments, the coating layer can have a thickness of no less than 50 nm, no less than 100 nm, no less than 200 nm, no less than 300 nm, no less than 400 nm, or even no less than 500 nm. Moreover, the coating layer can have a thickness in a range of any of the maximum and minimum values described above, such as, from about 200 nm to 20 microns, from 500 nm to 15 microns, or even 1 micron to 10 microns.

In particular embodiments, the composite can include additional layers, such as a protective layer or a hard coat layer. Such layers can be understood by one of ordinary skill in the art.

As discussed above, described herein are methods for making a coating material and methods for making a composite.

In certain embodiments, the method for making a coating material can include providing a binder system, providing particles, and dispersing the particles in the binder system. In particular embodiments, the method can include making a coating material having one or more of the characteristics of the coating material described in this disclosure. In further particular embodiments, the method can include mixing the binder system with particles, such as the particles described herein, in a solvent, such as methyl isobutyl ketone. In even further particular embodiments, the method can include providing a binder system having a refractive index that closely matches the refractive index of the particles.

In certain embodiments, the method for making a composite can include providing a substrate, providing a coating material, and applying the coating material to the substrate. In particular embodiments, providing a coating material can include the methods for making a coating material described herein. For example, the coating material can have one or more of the characteristics of the coating material described in this disclosure. In further embodiments, the method can include applying the coating material on the substrate to form a coating layer having a desired thickness, such as the thicknesses disclosed herein.

The present disclosure represents a departure from the state of the art. In particular, it has heretofore been unknown how to form an infrared-attenuating coating material that can provide the performance characteristics, and particularly the combination of performance characteristics described herein. For example, the present disclosure illustrates various electrodes having a dielectric layer and a layer comprising a metal. Such constructions as described in detail herein have unexpectedly been found to exhibit significantly lower haze contribution than were heretofore impossible to achieve.

Many different aspects and embodiments are possible. Some of those aspects and embodiments are described below. After reading this specification, skilled artisans will appreciate that those aspects and embodiments are only illustrative and do not limit the scope of the present invention. Embodiments can be in accordance with any one or more of the items as listed below.

Item 1. An infrared-attenuating coating material comprising:
particles having a refractive index of 2 or greater; and
a binder system having a refractive index of 1.53 or greater.

Item 2. An infrared-attenuating coating material having a haze contribution of no greater than 20% when applied to a transparent substrate and measured at a wavelength of 390 nm.

Item 3. An infrared-attenuating coating material comprising particles and a binder system, the particles and the binder system having a refractive index difference of no greater than 1.5.

Item 4. A composite comprising:
a substrate; and
an infrared-attenuating coating material that
(a) comprises a binder system and particles dispersed in the binder system, the particles having a refractive index of 2 or greater and the binder system having a refractive index of 1.53 or greater,
(b) has a haze contribution of no greater than 20% when applied to a transparent substrate and measured at a wavelength of 390 nm, or
(c) comprises particles and a binder system, the particles and the binder system having a refractive index difference of no greater than 1.5.

Item 5. A method of forming an infrared-attenuating coating material, the method comprising: providing particles and a binder system; and

mixing the particles and the binder system to form a coating material that
(a) comprises a binder system and particles dispersed in the binder system, the particles having a refractive index of 2 or greater and the binder system having a refractive index of 1.53 or greater,
(b) has a haze contribution of no greater than 20% when applied to a transparent substrate and measured at a wavelength of 390 nm, or
(c) comprises particles and a binder system, the particles and the binder system having a refractive index difference of no greater than 1.5.

Item 6. A method of forming a composite, the method comprising: providing a substrate, particles, and a binder system;

mixing the particles and the binder system to form a coating material that
(a) comprises a binder system and particles dispersed in the binder system, the particles having a refractive index of 2 or greater and the binder system having a refractive index of 1.53 or greater,
(b) has a haze contribution of no greater than 20% when applied to a transparent substrate, or
(c) comprises particles and a binder system, the particles and the binder system having a refractive index difference of no greater than 1.5; and
coating the substrate with the infrared-attenuating coating material.

Item 7. The coating material, composite or method of any one of the preceding items, wherein the coating material has a haze contribution of no greater than 20%, no greater than 15%, no greater than 12%, or no greater than 10%, no greater than 9%, or no greater than 8%, no greater than 7%, no greater than 6%, no greater than 5%, no greater than 4%, or even no greater than 3%.

Item 8. The coating material, composite or method of any one of the preceding items, wherein the coating material has a haze contribution of no less than 0.1%, no less than 0.2%, no less than 0.3%, no less than 0.4%, or no less than 0.5%.

Item 9. The coating material, composite or method of any one of the preceding items, wherein the coating material has a haze contribution in a range of from about 0.1% to about 20%, from 0.5% to 10%, from 1% to 8%, or from 2% to 5%.

Item 10. The coating material, composite or method of any one of the preceding items, wherein, when applied to a high-VLT substrate, the coating material has a haze contribution in a range of from 0.1% to 5%, from 0.5% to 4%, or from 1% to 3%.

Item 11. The coating material, composite or method of any one of the preceding items, wherein, when applied to a low-VLT substrate, the coating material has a haze contribution in a range of from 1% to 10%, from 4% to 9%, or from 6% to 8%.

Item 12. The coating material, composite or method of any one of the preceding items, wherein the refractive index difference is no greater than 1.4, no greater than 1.3, no greater than 1.2, or even no greater than 1.1.

Item 13. The coating material, composite or method of any one of the preceding items, wherein the refractive index difference is no less than 0.1, no less than 0.2, no less than 0.3, no less than 0.4, or no less than 0.5.

Item 14. The coating material, composite or method of any one of the preceding items, wherein the refractive index difference is in a range of from 0.1 to 1.5, from 0.3 to 1.3, or from 0.5 to 1.1.

Item 15. The coating material, composite or method of any one of the preceding items, wherein the particles comprise tungsten oxide, antimony tin oxide, indium tin oxide, lanthanum hexaboride, or any combination thereof.

Item 16. The coating material, composite or method of any one of the preceding items, wherein the particles comprise tungsten oxide composite particles having the general formula MₓW_{y}O_{z}, where M is Cs, Na, Rb, Ti, or any combination thereof.

Item 17. The coating material, composite or method of item 7, wherein M is Cs.

Item 18. The coating material, composite or method of items 7 and 8, wherein x has a value in a range of from 0.1 to 0.5, from 0.12 to 0.45, from 0.13 to 0.4, from 0.14 to 0.35, or from 0.15 to 0.33.

Item 19. The coating material, composite or method of any one of the preceding items, wherein the particles comprise a composite metal nitride.

Item 20. The coating material, composite or method of item 19, wherein the metal of the composite metal nitride comprises Ti, Ta, Zr, Hf, or any combination thereof.

Item 21. The coating material, composite or method of any one of the preceding items, wherein the particles comprise a composite metal hexaboride

Item 22. The coating material, composite or method of item 21, wherein the metal of the composite metal hexaboride comprises La, Ho, Dy, Tb, Gd, Nd, Pr, Ce, Y, Sm, or any combination thereof.

Item 23. The coating material, composite or method of any one of the preceding items, wherein the particles have a refractive index the particles of no less than 2.0, no less than 2.05, no less than 2.1, no less than 2.15, no less than 2.2, no less than 2.25, or no less than 2.3.

Item 24. The coating material, composite or method of any one of the preceding items, wherein the particles have a refractive index of no greater than 2.8, no greater than 2.75, no greater than 2.7, no greater than 2.65, or no greater than 2.6.

Item 25. The coating material, composite or method of any one of the preceding items, wherein the particles have a refractive index in a range of from 2.0 to 2.8, or from 2.1 to 2.75, or from 2.2 to 2.7, or from 2.3 to 2.65, or from 2.4 to 2.6.

Item 26. The coating material, composite or method of any one of the preceding items, wherein the particles comprise nanoparticles.

Item 27. The coating material, composite or method of any one of the preceding items, wherein the particles are nanoparticles having a diameter of no greater than 500 nm, such as no greater than 300 nm, no greater than 200 nm, no greater than 150 nm, or no greater than 100 nm.

Item 28. The coating material, composite or method of any one of the preceding items, wherein the particles are nanoparticles having a diameter of no less than 1 nm, no less than 20 nm, no less than 30 nm, or no less than 40 nm.

Item 29. The coating material, composite or method of any one of the preceding items, wherein the particles are nanoparticles having a diameter of in a range of from 20 nm to 200 nm, from 30 nm to 150 nm, or from 40 nm to 100 nm.

Item 30. The coating material, composite or method of any one of the preceding items, wherein the binder system comprises a monomer or oligomer or a UV curable monomer or oligomer.

Item 31. The coating material, composite or method of any one of the preceding items, wherein the binder system comprises an aromatic monomer or oligomer.

Item 32. The coating material, composite or method of any one of the preceding items, wherein the binder system comprises an acrylate monomer or oligomer, an epoxy acrylate monomer or oligomer, an aromatic epoxy acrylate monomer or oligomer, a partially-acrylated bisphenol A epoxy monomer or oligomer, a difunctional bisphenol A based epoxy acrylate blended with glyceryl propoxy triacrylate, or a brominated aromatic acrylate oligomer.

Item 33. The coating material, composite or method of any one of the preceding items, wherein the binder system comprises an acrylic resin, a mixture of an acrylate monomer and an acrylic resin, or an acrylic ester oligomer.

Item 34. The coating material, composite or method of any one of the preceding items, wherein binder system has a refractive index of no less than 1.50, no less than 1.51, no less than 1.52, or no less than 1.53.

Item 35. The coating material, composite or method of any one of the preceding items, wherein binder system has a refractive index of no greater than 1.65, no greater than 1.62, no greater than 1.61, or no greater than 1.60.

Item 36. The coating material, composite or method of any one of the preceding items, wherein binder system has a refractive index in a range of from 1.50 to 1.65, from 1.53 to 1.62, or from 1.55 to 1.60.

Item 37. The coating material, composite or method of any one of the preceding items, wherein the coating material comprises the particles in an amount of at least 1 wt. %, such as in a range of from about 1 wt. % to about 30 wt. %, such as from about 5 wt. % to about 20 wt. %,such as from about 9 wt. % to about 15 wt. %, based on the total weight of the infrared-attenuating coating material.

Item 38. The coating material, composite or method of any one of the preceding items, wherein the coating material comprises the binder system in an amount of no greater than 99 wt. %, no greater than 98 wt. %, no greater than 97 wt. %, no greater than 93 wt. %, no greater than 94 wt. %, no greater than 93 wt. %, no greater than 92 wt. %, or no greater than 91 wt. %.

Item 39. The coating material, composite or method of any one of the preceding items, wherein the coating material comprises the binder system in an amount of no less than 15 wt. %, no less than 20 wt. %, no less than 25 wt. %, no less than 30 wt. %, no less than 35 wt. %, or no less than 40 wt. %.

Item 40. The coating material, composite or method of any one of the preceding items, wherein the coating material comprises the binder system in a range of from about 99 wt. % to 70 wt. %, or from 95 wt. % to 80 wt. %, or from 91 wt. % to 85 wt. %.

Item 41. The coating material, composite or method of any one of the preceding items, wherein the difference between the refractive index of the particles and the refractive index of the binder system is no greater than 1.5, no greater than 1.4, no greater than 1.3, no greater than 1.2, or no greater than 1.1.

Item 42. The coating material, composite or method of any one of the preceding items, wherein the difference between the refractive index of the particles and the refractive index of the binder system is no greater than 1.5, no greater than 1.4, no greater than 1.3, no greater than 1.2, or no greater than 1.1.

Item 43. The coating material, composite or method of any one of the preceding items, wherein the difference between the refractive index of the particles and the refractive index of the binder system is no less than 0.1, no less than 0.2, no less than 0.3, no less than 0.4, or no less than 0.5.

Item 44. The coating material, composite or method of any one of the preceding items, wherein the difference between the refractive index of the particles and the refractive index of the binder system is from 0.1 to 1.5, from 0.3 to 1.3, or from 0.5 to 1.1.

Item 45. The composite or method of any one of the preceding items, wherein the composite has a visible light transmission of 65% or greater, such as 68% or greater, such as 70% or greater, such as 73% or greater, such as 75% or greater, such as 78% or greater, such as 80% or greater, as measured according to a spectrophotomer.

Item 46. The composite or method of any one of the preceding items, wherein the composite has a light to solar heat gain coefficient (LSHGC) of at least 1, such as at least 1.1, such as at least, 1.2, such as at least, 1.3, such as at least 1.4, such as at least 1.5, such as at least 1.6, as measured according to a spectrophotomer and calculated by Window software.

Item 47. The composite or method of any one of the preceding items, wherein the composite has a light to solar heat gain coefficient (LSHGC) of no greater than 1.95, no greater than 1.92, or no greater than 1.90.

Item 48. The composite or method of any one of the preceding items, wherein the composite has a light to solar gain coefficient (LSHGC) in a range of 1.60 to 1.95 or 1.80 to about 1.90.

Item 49. The composite or method of any one of the preceding items, wherein the composite has a haze of no greater than 30%, no greater than 25%, no greater than 20%, no greater than 15%, no greater than 10%, no greater than 9%, no greater than 8%, no greater than 7%, no greater than 6%, no greater than 5%, no greater than 4%, or even no greater than 3%.

Item 50. The composite or method of any one of the preceding items, wherein the composite has a haze of no less than 0.1%, no less than 0.5%, or no less than 1%.

Item 51. The composite or method of any one of the preceding items, wherein the composite has a haze in a range of from 0.1% to 10%, from 0.5% to 8%, or even from 1% to 3%.

Item 52. The composite, or method of forming a composite, of any one of the preceding claims, wherein the haze contribution of the coating layer is no greater than 15%, no greater than 12%, no greater than 10%, or no greater than 9%, or no greater than 8%.

Item 53. The composite, or method of forming a composite, of any one of the preceding items, wherein the haze contribution of the coating layer is no less than 0.1%, no less than 0.2%, no less than 0.3%, no less than 0.4%, or no less than 0.5%.

Item 54. The composite, or method of forming a composite, of any one of the preceding items, wherein the haze contribution of the coating layer is in a range of from about 0.1% to about 15%, from 0.5% to 10%, or from 1% to 8%.

Item 55. The composite, or method of forming a composite, of any one of the preceding items, wherein the composite has a total solar energy rejection (TSER) of no less than 35%, no less than 52%, no less than 55%, or even no less than 59%.

Item 56. The composite, or method of forming a composite, of any one of the preceding items, wherein the composite has a total solar energy rejection (TSER) of no greater than 90%, no greater than 80%, or even no greater than 70%.

Item 57. The composite, or method of forming a composite, of any one of the preceding items, wherein the composite has a total solar energy rejection (TSER) in a range of 50% to 90%, or 59% to 90%.

Item 58. The composite, or method of forming a composite, of any one of the preceding items, wherein the composite has a total solar energy absorptance (TSEA) of no less than 30%, no less than 40%, no less than 50%, no less than 60%, or even no less than 70%, as measured by a spectrophotometer and calculated with the Window software.

Item 59. The composite, or method of forming a composite, of any one of the preceding items, wherein the composite has a total solar energy absorptance (TSEA) of 100%, or no greater than 95%, or no greater than 90%, or even no greater than 85%.

Item 60. The composite, or method of forming a composite, of any one of the preceding items, wherein the composite has a total solar energy absorptance (TSEA) in a range of 30% to 100%, or 40% to 95%, or from 70% to 90%.

Item 61. The composite, or method of forming a composite, of any one of the preceding items, wherein
the composite has a total solar energy rejection (TSER) of has a total solar energy reflectance (TSER) in a range of 50% to 90%, or 59% to 80%,
the composite has a total solar energy absorptance (TSEA) in a range of 30% to 100%, or 40% to 95%, or from 70% to 90%, as measured by a spectrophotometer and calculated with the Window software, and
the coating layer has a haze contribution in a range of from about 0.1% to about 15%, from 0.5% to 10%, or from 1% to 8%.

Item 62. The composite, or method of forming a composite, of any one of the preceding items, wherein the substrate is a polymer, such as a flexible polymer, such as a transparent polymer.

Item 63. The composite, or method of forming a composite, of any one of the preceding items, wherein the substrate is a dyed, metalized, or extruded substrate having a VLT of 35% or greater.

Item 64. The composite, or method of forming a composite, of any one of the preceding items, wherein the substrate is glass.

Item 65. The composite, or method of forming a composite, of item 28, wherein the polymer is polycarbonate, polyacrylate, polyester, polyethylene, polypropylene, polyurethane, fluoropolymer, cellulose triacetate polymer, or any combination thereof.

Item 66. The composite, or method of forming a composite, of item 28, wherein the substrate has a VLT in a range of any of the maximum and minimum values described above, such as in the range of from 30% to 65% or 35% to 60%.

Item 67. The composite, or method of forming a composite, of item 28, wherein the substrate has a VLT in a range of such as in a range of from 60% to 85% or even from 65% to 80%, or 65% to 75%.

Item 68. The composite, or method of forming a composite, of any one of the preceding items, wherein the substrate comprises an infrared reflecting substrate.

Item 69. The composite, or method of forming a composite, of item 55, wherein the infrared reflecting substrate comprises an infrared reflecting film.

Item 70. The composite, or method of forming a composite, of any one of the preceding items, wherein the coating material is coated on a major surface of the substrate.

Item 71. The composite, or method of forming a composite, of any one of the preceding items, wherein the coating material has a thickness of no greater than 50 microns, no greater than 20 microns, or no greater than 10 microns.

Item 72. The composite, or method of forming a composite, of any one of the preceding items, wherein the coating material has a thickness of no less than 50 nm, no less than 100 nm, no less than 200 nm, no less than 300 nm, no less than 400 nm, or even no less than 500 nm.

Item 73. The composite, or method of forming a composite, of any one of the preceding items, wherein the coating material has a thickness in a range of from about 200 nm to 20 microns, from 500 nm to 15 microns, or even 1 micron to 10 microns.

These and other unexpected and superior characteristics are illustrated in the Example below, which are exemplary and not limiting, in any way, to the embodiments described herein.

### EXAMPLES

For the following examples, the specified materials were mixed together, coated onto a substrate, and UV-cured. Each example was measured to determine the haze contribution of the coating layer. The haze values were measured using the ASTM D1003 method.

### Example 1

Two different high-refractive index monomers were used for Example 1, one an epoxy acrylate (Ebecryl 3605, RI=1.56) and the other a mixture of acrylated monomer and acrylic resin (Cytec Ex 15039, RI=1.59) were each mixed with a cesium tungsten oxide (RI=2.5-2.6) dispersion (Sumitomo Metal Mining, YMF-02A) at a ratio of approximately 50% binder and 50% dispersion and initiator was added. The mixtures were coated using Mayer rod coating onto a superclear PET film with a thickness resulting in a VLT of approximately 77% and UV-cured. The haze as a function of wavelength for these two monomers was compared to the haze as a function of wavelength for two samples prepared in the same manner as above but using different low refractive index systems: CN2920 (RI=1.48) and CN9006 (RI=1.49).

The solar performance data is summarized in Table 1.

TABLE 1

| Binder | Substrate | LT | TSER | LSHGC | TSEA |
|---|---|---|---|---|---|
| Ebecryl 3605 | Clear PET | 6 | 3 | 1.33 | 1 |
| Cytec Ex 15039 | Clear PET | 9 | 9 | 1.29 | 3 |
| CN2920 | Clear PET | 8 | 1 | 1.33 | 8 |
| CN9006 | Clear PET | 8 | 1 | 1.31 | 7 |

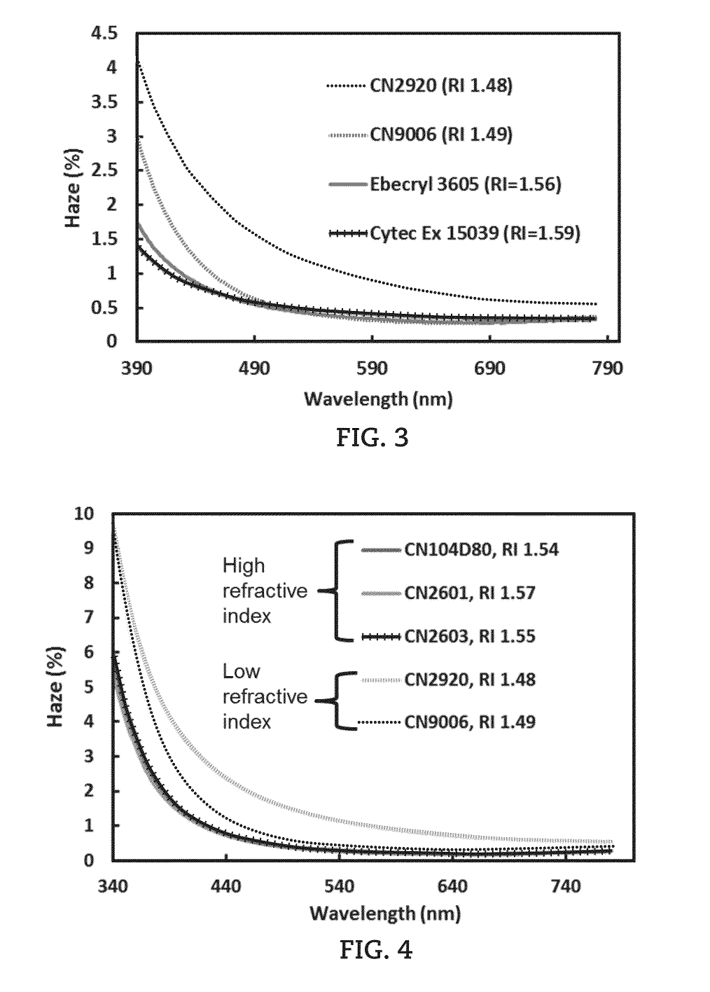

As shown in FIG. 3, the haze was lower for the high refractive index monomer coatings, especially at the shorter wavelengths of light. The HCᵥₗₜ values shown in Table 2 indicate that the HCᵥₗₜ was significantly lower for the binder systems with high refractive index.

TABLE 2

| Binder | HCᵥₗₜ |
|---|---|
| CN2920 | 14.9 |
| CN9006 | 9.1 |
| Ebecryl 3605 | 2.9 |
| Cytec Ex. 15039 | 1.9 |

### Example 2

Three different high refractive index binders were used for Example 2. The first was a difunctional bisphenol A based epoxy acrylate blended with glyceryl propoxy triacrylate (CN104D80, RI=1.54). The second was a brominated aromatic acrylate oligomer (CN2601, RI=1.57). The third was an acrylic ester oligomer (CN2603, RI=1.55). Composites having a coating layer comprising these high refractive index binder systems were compared to two composites having a coating layer comprising low refractive index binders. The first low refractive index binder was an aliphatic urethane acrylate oligomer (CN2920, RI=1.48) and the second low refractive index binder was a hexafunctional aliphatic urethane acrylate oligomer (CN9006, RI=1.49). For the study, each binder system was mixed with a cesium tungsten oxide nanoparticle (RI=2.5-2.6) dispersion (Sumitomo Metal Mining, YMF-02A) at a ratio of 50% binder to 50% dispersion and initiator was added. The mixtures were coated onto a superclear PET film with a thickness resulting in a VLT of approximately 77% and UV cured.

The solar performance data is summarized in Table 3.

TABLE 3

| Binder | Substrate | LT | SER | LSHGC | TSEA |
|---|---|---|---|---|---|
| CN104D80 | Clear PET | 78 | 41 | 1.32 | 50 |
| CN2601 | Clear PET | 76 | 43 | 1.34 | 52 |
| CN2603 | Clear PET | 77 | 41 | 1.31 | 49 |
| CN2920 | Clear PET | 78 | 41 | 1.33 | 48 |
| CN9006 | Clear PET | 78 | 41 | 1.31 | 47 |

As shown in FIG. 4, the haze as a function of wavelength for the different coatings indicates that the haze is lower for the coatings with high refractive index binders. Table 4 shows the HCᵥₗₜ values for the coatings in this example. The HCᵥₗₜ values are significantly lower for the high refractive index binders than for the low refractive index binders.

TABLE 4

| Binder | HCᵥₗₜ |
|---|---|
| CN2920 | 14.9 |
| CN9006 | 9.1 |
| CN104D80 | 3.1 |
| CN2601 | 2.6 |
| CN2603 | 3.5 |

### Example 3

An epoxy acrylate high refractive index binder CN2602 (RI=1.56) and an aliphatic urethane acrylate low refractive index binder CN2920 (RI=1.48) were used for Example 3. Each were mixed with a cesium tungsten oxide (RI=2.5-2.6) nanoparticle dispersion (Sumitomo Metal Mining, YMF-02A) at a ratio of 50% binder and 50% dispersion and initiator was added. The mixtures were coated onto glass using Mayer Rod coating at a thickness resulting in a visible light transmission of approximately 40% and UV cured.

The solar performance data is summarized in Table 5

TABLE 5

| Binder | Substrate | VLT | TSER | LSHGC | TSEA |
|---|---|---|---|---|---|
| CN2602 | Glass | 36 | 61 | 0.93 | 80 |
| CN2920 | Glass | 38 | 60 | 0.96 | 81 |

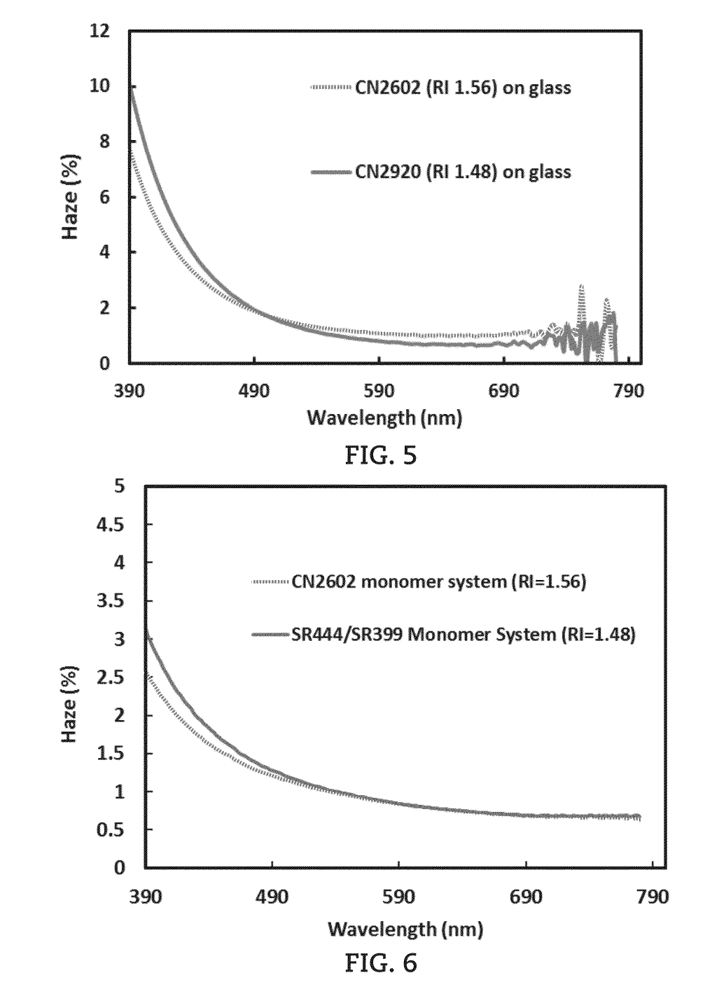

As shown in FIG. 5, the haze of the coating with the high refractive index binder was lower than that with the low refractive index binder at short wavelengths. The HCᵥₗₜ for the CN2602-based coating was 11.95 and for the CN2920-based coating was 15.97, indicating that the haze contribution is lower for the high refractive index binder system than for the low refractive index binder system.

### Example 4

Two different binder systems were used for Example 4. Each were mixed with a cesium-doped tungsten oxide nanoparticle system (nanoparticle refractive index, RI=2.5-2.6). The first is a blend of SR444/SR399 (blend of pentaerythritol triacrylate and dipentaerythritol pentaacrylate) UV-cured binder (RI=approximately 1.48). The second is a UV-cured binder that is based on epoxy acrylate (CN2602, RI=1.56), higher than that of the standard coating binder. For each binder system, a cesium-doped tungsten oxide nanoparticle dispersion (Sumitomo Metal Mining, YMF-02A) was mixed with the UV curable binder at a ratio of approximately 50% binder and 50% dispersion and initiator was added. The solution was coated on a PET substrate using the Mayer rod coating method to obtain a VLT of approximately 77% and UV cured. The solar performance data is summarized in Table 6.

TABLE 6

| Binder | Substrate | VLT | TSER | LSHGC | TSEA |
|---|---|---|---|---|---|
| SR444/SR399 | Clear PET | 77 | 44 | 1.35 | 52 |
| CN2602 | Clear PET | 77 | 44 | 1.35 | 54 |

The PET substrate has an inherent haze of approximately 2.2% at 390 nm, so examining the HC_{coating} was extremely important. As shown in FIG. 6, the haze profile of the high refractive index binder system shows lower haze at low wavelengths than the lower refractive index binder system. For the SR444/SR399 binder system, HCᵥₗₜ=4.7% and for the CN2602 binder system, HCᵥₗₜ=1.6%, a significantly lower value.

### Example 5

Samples for Example 5 were prepared using an epoxy acrylate high refractive index binder (CN2602, RI=1.56) and an aliphatic urethane acrylate low refractive index binder (CN2920, RI=1.48). Each were mixed with a cesium tungsten oxide (RI=2.5-2.6) nanoparticle dispersion (Sumitomo Metal Mining, YMF-02A) at a ratio of approximately 50% binder and 50% dispersion and initiator was added. The mixtures were coated onto superclear PET using Mayer Rod coating at a thickness resulting in a visible light transmission of approximately 66% and UV cured.

The solar performance data is summarized in Table 7.

TABLE 7

| Binder | Substrate | VLT | TSER | LSHGC | TSEA |
|---|---|---|---|---|---|
| CN2602 | Clear PET | 65 | 51 | 1.32 | 64 |
| CN2920 | Clear PET | 68 | 50 | 1.34 | 64 |

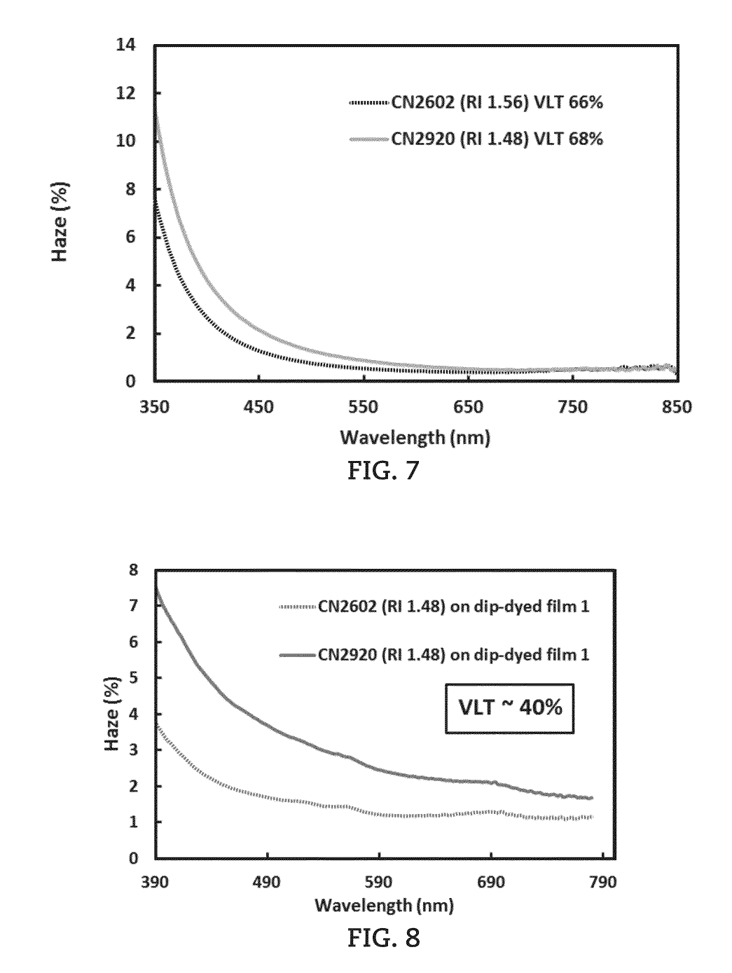

As shown in FIG. 7, the haze of the coating with the high refractive index binder was lower than that with the low refractive index binder. The HCᵥₗₜ for the CN2602-based coating is 6.3, while the HCᵥₗₜ for the CN2920-based coating is 12.4, indicating that the haze contribution is lower for the high refractive index binder system than for the low refractive index binder system.

### Example 6

Samples for Example 6 are prepared using an epoxy acrylate high refractive index binder (CN2602, RI=1.56) and an aliphatic urethane acrylate low refractive index binder (CN2920, RI=1.48). Each are mixed with a cesium tungsten oxide (RI=2.5-2.6) nanoparticle dispersion (Sumitomo Metal Mining, YMF-02A) at a ratio of approximately 50% binder and 50% dispersion and initiator was added. The mixtures are coated onto two different dyed PET films using Mayer Rod coating at a thickness resulting in a visible light transmission of approximately 40-50% and UV cured. Dip-dyed film 1 has an inherent visible light transmission of 50%, dip-dyed film 2 has an inherent visible light transmission of 70%, and dip-dyed film 3 has an inherent visible light transmission of 52%. The overall visible light transmissions of the coated films are 40%, 50%, and 48% for coated dip-dyed film 1, dip-dyed film 2, and dip-dyed film 3, respectively.

The solar performance data is summarized in Table 8.

TABLE 8

| Binder | Substrate | VLT | TSER | LSHGC | TSEA |
|---|---|---|---|---|---|
| CN2602 | Dip-dyed film 1 | 41 | 58 | 0.97 | 77 |
| CN2920 | Dip-dyed film 1 | 43 | 57 | 1.00 | 76 |
| CN2602 | Dip-dyed film 2 | 51 | 55 | 1.14 | 72 |
| CN2920 | Dip-dyed film 2 | 51 | 56 | 1.15 | 71 |
| CN2602 | Dip-dyed film 3 | 48 | 56 | 1.11 | 74 |
| CN2920 | Dip-dyed film 3 | 48 | 56 | 1.12 | 73 |

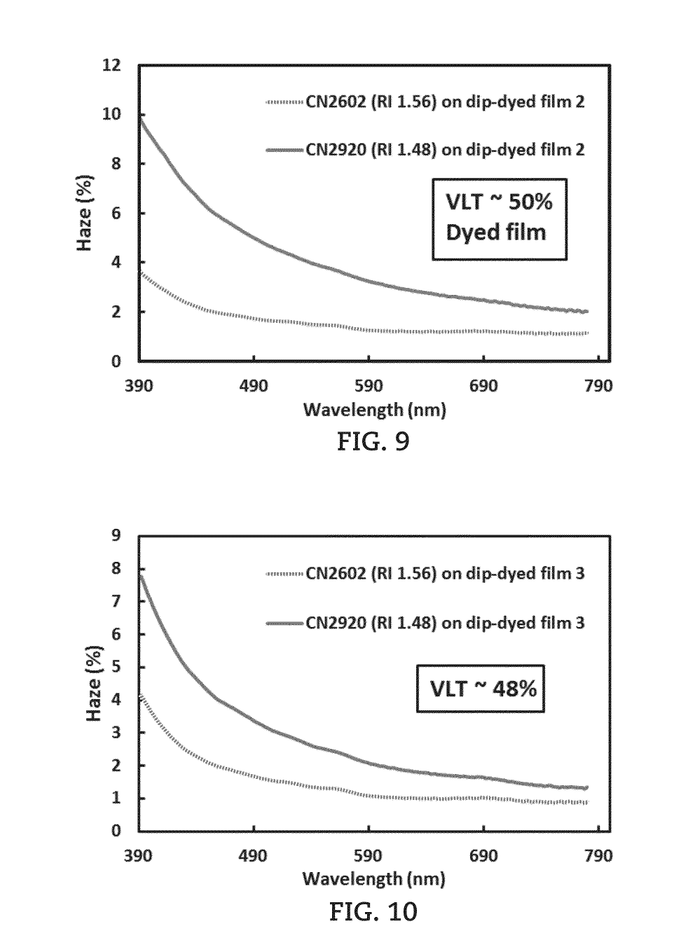

As shown in FIGS. 8-10, the haze of the coating with the high refractive index binder was lower than that with the low refractive index binder for all three cases. The haze contributions of the six different coated samples are shown in Table 9. The HCᵥₗₜ values are significantly lower for the coatings with the high refractive index binder (CN2602) than with the low refractive index binder (CN2920).

TABLE 9

| Substrate | Binder | HCᵥₗₜ |
|---|---|---|
| Dip-dyed film 1 | CN2920 | 10.85 |
| Dip-dyed film 2 | CN2920 | 16.49 |
| Dip-dyed film 3 | CN2920 | 12.50 |
| Dip-dyed film 1 | CN2602 | 4.22 |
| Dip-dyed film 2 | CN2602 | 3.69 |
| Dip-dyed film 3 | CN2602 | 5.42 |

### Example 7

Samples for Example 7 were prepared using an epoxy acrylate high refractive index binder (CN2602, RI=1.56) and an aliphatic urethane acrylate low refractive index binder (CN2920, RI=1.48). Each were mixed with a cesium tungsten oxide (RI=2.5-2.6) nanoparticle dispersion (Sumitomo Metal Mining, YMF-02A) at a ratio of approximately 50% binder and 50% dispersion and initiator was added. The mixtures were coated onto a metallized PET film using Mayer Rod coating at a thickness resulting in a visible light transmission of approximately 45% and UV cured. The metallized film has an inherent visible light transmission of 55%. The overall visible light transmission of the coated film was 45%.

The solar performance data is summarized in Table 10.

TABLE 10

| Binder | Substrate | VLT | TSER | LSHGC | TSEA |
|---|---|---|---|---|---|
| CN2602 | Metallized film | 45 | 56 | 1.03 | 75 |
| CN2920 | Metallized film | 45 | 60 | 1.13 | 62 |

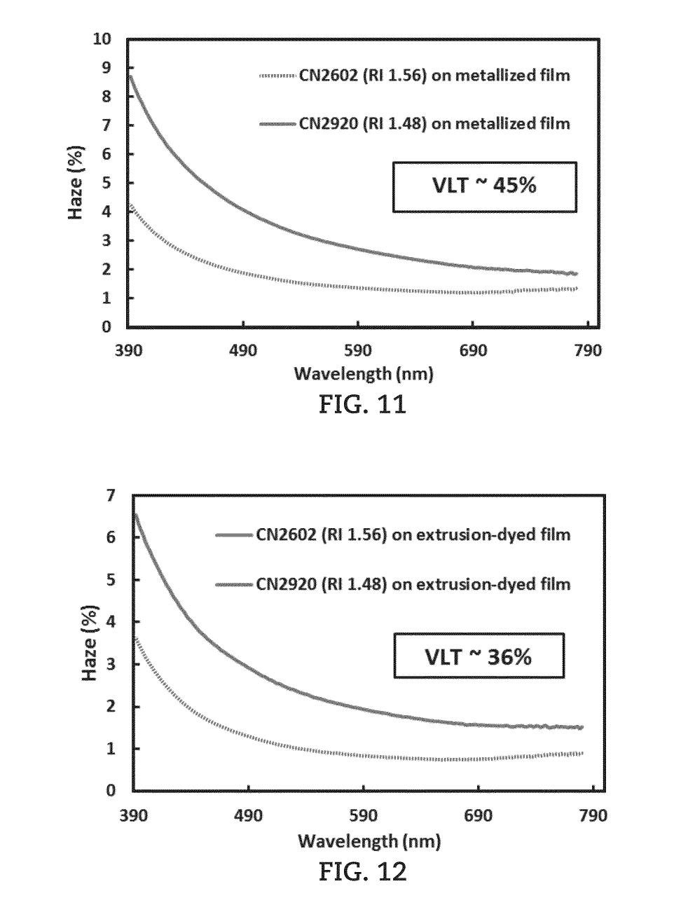

As shown in FIG. 11, the haze of the coating with the high refractive index binder was lower than that with the low refractive index binder. The HCᵥₗₜ for CN2920 on the metallized film is 12.50 and for CN2602 on the metallized film is 4.25, indicating that the haze contribution of the coating is lower for the coating with the high refractive index binder than for the coating with the low refractive index binder.

### Example 8

Samples for Example 8 are prepared using an epoxy acrylate high refractive index binder (CN2602, RI=1.56) and an aliphatic urethane acrylate low refractive index binder (CN2920, RI=1.48). Each were mixed with a cesium tungsten oxide (RI=2.5-2.6) nanoparticle dispersion (Sumitomo Metal Mining, YMF-02A) at a ratio of approximately 50% binder and 50% dispersion and initiator was added. The mixtures are coated onto a dark, extrusion-dyed PET film. The extrusion-dyed film has an inherent visible light transmission of 48%. The overall visible light transmission of the coated film is 36%.

The solar performance data is summarized in Table 11.

TABLE 11

| Binder | Substrate | VLT | TSER | LSHGC | TSEA |
|---|---|---|---|---|---|
| CN2602 | Extrusion-dyed film | 37 | 58 | 0.88 | 76 |
| CN2920 | Extrusion-dyed film | 38 | 56 | 1.03 | 75 |

As shown in FIG. 12, the haze of the coating with the high refractive index binder is lower than that with the low refractive index binder. The HCᵥₗₜ for CN2920 on the extrusion-dyed film is 7.27 and for CN2602 on the extrusion-dyed film is 2.62, indicating that the haze contribution of the coating is lower for the coating with the high refractive index binder than for the coating with the low refractive index binder.

Note that not all of the activities described above in the general description or the examples are required, that a portion of a specific activity cannot be required, and that one or more further activities can be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments can also be provided in combination in a single embodiment, and conversely, various features that are, for brevity, described in the context of a single embodiment, can also be provided separately or in any subcombination. Further, reference to values stated in ranges includes each and every value within that range. Many other embodiments can be apparent to skilled artisans only after reading this specification. Other embodiments can be used and derived from the disclosure, such that a structural substitution, logical substitution, or another change can be made without departing from the scope of the disclosure. Accordingly, the disclosure is to be regarded as illustrative rather than restrictive.

1. An infrared-attenuating coating material comprising:
particles having a refractive index of 2 or greater; and
a binder system having a refractive index of 1.53 or greater.

2. The coating material of claim 1, wherein the coating material has a haze contribution in a range of from about 0.1% to about 20%.

3. The coating material of claim 1, wherein, when applied to a low-VLT substrate, the coating material has a haze contribution in a range of from 1% to 10%.

4. The coating material of claim 1, wherein the refractive index difference is in a range of from 0.1 to 1.5.

5. The coating material of claim 1, wherein the particles comprise tungsten oxide, antimony tin oxide, indium tin oxide, lanthanum hexaboride, or any combination thereof.

6. The coating material of claim 1, wherein the particles comprise tungsten oxide composite particles having the general formula MₓW_{y}O_{z}, where M is Cs, Na, Rb, Ti, or any combination thereof.

7. The coating material of claim 6, wherein x has a value in a range of from 0.1 to 0.5.

8. The coating material of claim 1, wherein the particles are nanoparticles having a diameter of no greater than 500 nm.

9. The coating material of claim 1, wherein the particles are nanoparticles having a diameter of no less than 1 nm.

10. The coating material of claim 1 wherein the coating material comprises the binder system in an amount of no greater than 99 wt. %.

11. The coating material of claim 1, wherein the coating material comprises the binder system in an amount of no less than 15 wt. %.

12. The coating material of claim 1, wherein the difference between the refractive index of the particles and the refractive index of the binder system is no less than 0.1.

13. An infrared-attenuating coating material having a haze contribution of no greater than 20% when applied to a transparent substrate and measured at a wavelength of 390 nm.

14. The coating material of claim 13, wherein the coating material has a haze contribution in a range of from about 0.1% to about 20%.

15. The coating material of claim 13, wherein, when applied to a low-VLT substrate, the coating material has a haze contribution in a range of from 1% to 10%.

16. The coating material of claim 13, wherein the refractive index difference is in a range of from 0.1 to 1.5.

17. An infrared-attenuating coating material comprising particles and a binder system, the particles and the binder system having a refractive index difference of no greater than 1.5.

18. The coating material of claim 17, wherein the particles comprise tungsten oxide, antimony tin oxide, indium tin oxide, lanthanum hexaboride, or any combination thereof.

19. The coating material of claim 17, wherein the particles comprise tungsten oxide composite particles having the general formula MₓW_{y}O_{z}, where M is Cs, Na, Rb, Ti, or any combination thereof.

20. (canceled)
